(19) United States
(12) Patent Application Publication
(10) Pub. No.: US 2010/0060379 A1
(43) Pub. Date: Mar. 11, 2010

(54) DELAY LINE FOR PRINTED CIRCUIT BROAD

(75) Inventors: Chia-Hsing Chou, Taipei (TW); Chih-Wei Tsai, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/550,398

(22) Filed: Aug. 30, 2009

(30) Foreign Application Priority Data
Sep. 5, 2008 (TW) 97134215

(51) Int. Cl. H01P 9/00

(52) U.S. Cl. 333/156

(57) ABSTRACT

A delay line for a printed circuit board (PCB) is disclosed. The delay line includes a first straight line, a second straight line and a third straight line. The second and third straight lines are respectively disposed at two sides of the first straight line. The first, second and third straight lines are parallel to each other and form a delay path. The current direction of the second straight line is opposite to that of the third straight line.

### CROSS-REFERENCE TO RELATED APPLICATION

This application claims the priority benefit of Taiwan application serial no. 97134215, filed on Sep. 5, 2008. The entirety of the above-mentioned patent application is hereby incorporated by reference herein and made a part of specification.

### BACKGROUND OF THE INVENTION

1. Filed of the Invention

The invention relates to a delay line and, more particularly, to a delay line which may reduce a cross talk effect.

2. Description of the Related Art

In digital signal design, to receive signals synchronously, the time for transmitting signals from the transmitting end to the receiving end is preferably the same. Thus, the circuits should be designed to have the same lengths. However, due to the layout, it is impossible for every line to be designed as straight line, and then a conventional delay line is designed. The designing way of a conventional delay line is to lay the straight delay line at a small area in an S layout mode. FIG. 1 is a schematic diagram showing a delay line according to the conventional technology. Since a cross talk effect may be generated due to a self coupling effect in the conventional delay line design, the signal transmitted by the delay line may reach the receiving end earlier than the signal transmitted by the straight line having the same length. This may lead to signal misdiagnosis. In addition, impedance mismatch may occur, which causes over-shoot or under-shoot.

FIG. 2 is a schematic diagram showing the signal waveform obtained according to the delay line in FIG. 1. In FIG. 2, the length of the delay line is the same as the length of the straight line. The signal S1 (dash line) denotes the waveform of the signal transmitted by the delay line, and the signal S2 (solid line) denotes the waveform of the signal transmitted by the straight line. Supposing that a 0.5 volt voltage is used as a reference voltage (such as the reference voltage of the logic high level), as shown in FIG. 2, the signal S1 reaches the 0.5 volt voltage earlier than the signal S2 at the time T1.

In addition, in the conventional technology, the layout distances SW (as shown in FIG. 1) of the delay line may be increased to reduce the affection made by the cross talk effect on the signal transmission. However, this may increase the layout area of the delay line.

### BRIEF SUMMARY OF THE INVENTION

The invention discloses a delay line adapted to a printed circuit board (PCB). By adjusting a current direction in the delay line, a signal coupling effect may be counteracted. Hence, a cross talk effect and a signal distortion may be reduced, and an area for layout in the circuit board also may be reduced.

The invention provides a delay line adapted to a PCB. The delay line includes a first straight line, a second straight line and a third straight line. The second straight line is adjacent to one side of the first straight line. The third straight line is located at the other side of the first straight line. The first straight line, the second straight line and the third straight line are parallel with each other to form a delay path. The current direction of the second straight line is opposite to the current direction of the third straight line.

In an embodiment of the invention, the delay line further includes a first connecting line and a second connecting line. The first connecting line is used to connect an end of the first straight line and an end of the second straight line. The second connecting line is used to connect the other end of the second straight line and an end of the third straight line. The first straight line, the second straight line, the third straight line, the first connecting line and the second connecting line form the delay path.

In an embodiment of the invention, the current direction of the first straight line is the same as that of the third straight line.

In an embodiment of the invention, the distance between the second straight line and the first straight line is the same as the distance between the second straight line and the third straight line.

In an embodiment of the invention, the delay path formed by the delay line is spiral.

In an embodiment of the invention, the delay line further includes a fourth straight line adjacent to the second straight line and parallel with the second straight line. An end of the fourth straight line is connected to an end of the third straight line, and the current direction of the fourth straight line is the same as the current direction of the second straight line.

In an embodiment of the invention, the delay line further includes a fourth straight line adjacent to the third straight line and parallel with the third straight line. An end of the fourth straight line is connected to an end of the third straight line, and the current direction of the fourth straight line is opposite to the current direction of the third straight line.

In an embodiment of the invention, the distance between the first straight line and the second straight line is the same as the distance between the first straight line and the third straight line.

The invention further includes a delay line adapted to a PCB. The delay line includes a line group and a third straight line. The line group has a first straight line and a second straight line, and the current direction of the first straight line is the same as that of the second straight line. The third straight line is adjacent to the line group at a side, and the current direction of the third straight line is opposite to the current direction of the line group. The first straight line, the second straight line and the third straight line are parallel with each other to form a delay path.

The invention further provides a delay line adapted to a PCB including a plurality of first straight lines, a plurality of first connecting lines, a plurality of second straight lines and a plurality of second connecting lines. The first connecting lines are connected to the first straight lines, respectively. The first connecting lines and the first straight lines wind from inside to outside along the first direction to form a first spiral trace. The second connecting lines are connected to the second straight lines, respectively. The second connecting lines and the second straight lines wind from inside to outside along a second direction to form a second spiral trace. The second spiral trace is located at the surrounding of the first spiral trace, and an end of the second spiral trace is connected to an end of the first spiral trace to form a delay path.

In an embodiment of the invention, the first spiral trace is formed by four first straight lines and three first connecting lines, and the second spiral trace is formed by four second straight lines and three second connecting lines.

In an embodiment of the invention, the first straight lines and the second straight lines are parallel with each other, and the distances between the first straight lines and the second straight lines are the same.

In an embodiment of the invention, the lengths of the first straight lines are greater than lengths of the first connecting lines, and the lengths of the second straight lines are greater than the lengths of the second connecting lines.

In an embodiment of the invention, if the first direction is counter-clockwise, the second direction is clockwise. If the first direction is clockwise, the second direction is counter-clockwise.

In an embodiment of the invention, the first spiral trace winds for two windings from inside to outside along the counter-clockwise direction, and the second spiral trace winds from inside to outside along the clockwise direction.

In the invention, since an odd-even mode balance structure is constructed, signal coupling effect may be counteracted due to the opposite current directions in adjacent lines. Thus, the cross talk effect in the whole delay line is reduced, the signal distortion in the conventional delay line is improved, and the area for layout needed by the delay line is also reduced.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a delay line in the conventional technology;

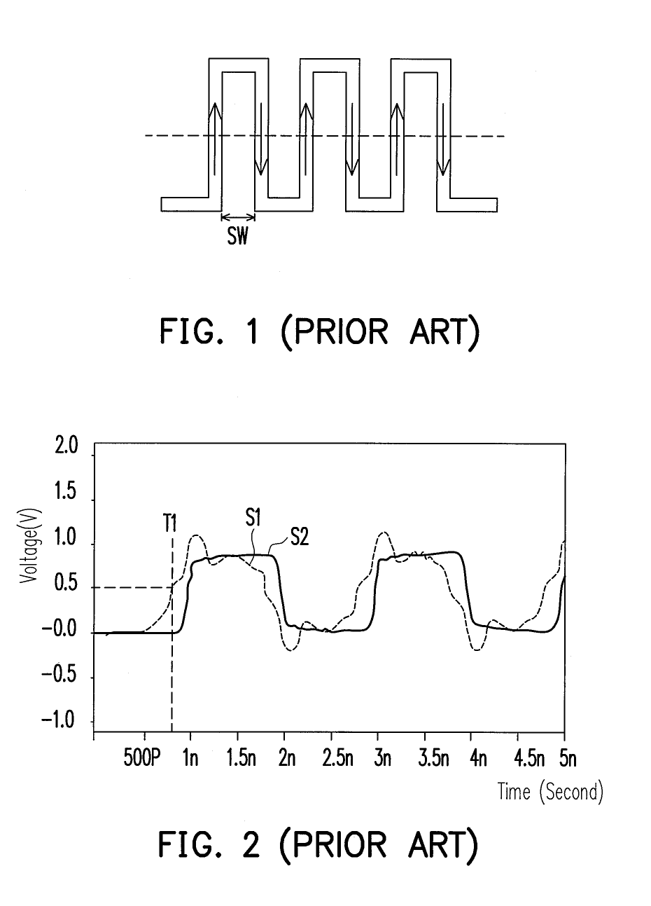

FIG. 2 is a schematic diagram showing a signal waveform according to FIG. 1;

FIG. 3 is a schematic diagram showing the delay line layout according to the first embodiment of the invention;

FIG. 4 is a sectional diagram taken along the sectional line I I′ in FIG. 3;

FIG. 5A to FIG. 5D are schematic diagrams showing the current directions of the straight lines in an embodiment of the invention;

FIG. 6A to FIG. 6D are the schematic diagrams showing the delay lines corresponding to FIG. 5A to FIG. 5D;

FIG. 7 is a schematic diagram showing the delay line in the second embodiment of the invention; and

FIG. 8 is a schematic diagram showing the signal waveform according to FIG. 7.

### DETAILED DESCRIPTION OF THE EMBODIMENTS

### The First Embodiment

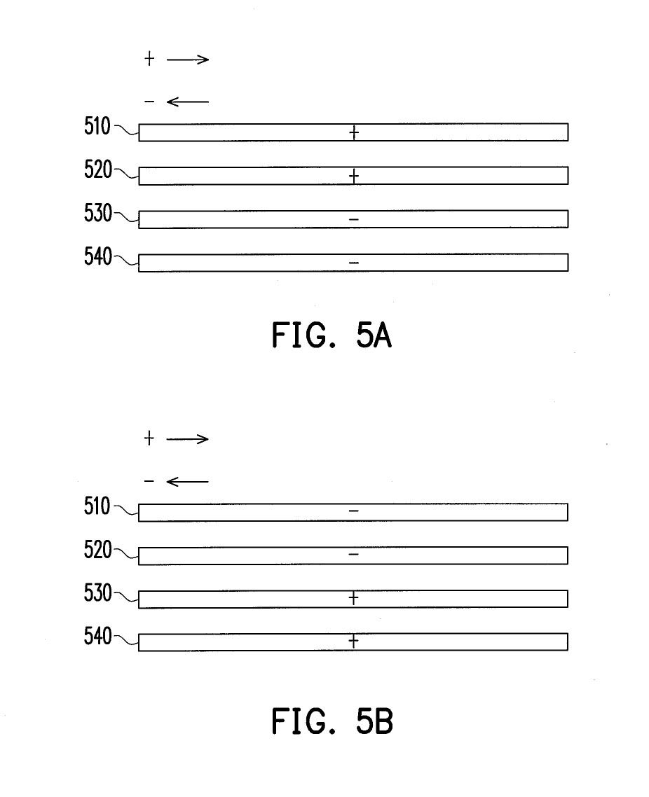

FIG. 3 is a schematic diagram showing a delay line layout in the first embodiment of the invention. As shown in FIG. 3, the delay line 300 includes three straight lines 310, 320 and 330. The current directions of the straight lines 310, 320 and 330 are denoted by the symbols + and −. The symbol + denotes a rightward direction, and the symbol − denotes a leftward direction. Thus, in the straight line 320, the current direction is rightward, and in the straight line 330, the current direction is leftward. Therefore, the delay line 300 forms an odd-even mode balance circuit structure. Since the odd-even mode balance circuit structure may counteract a cross talk effect, the distances SW1 between the straight lines 310, 320 and 330 are reduced, and the layout area of the delay line 300 is also reduced. In other words, for each straight line having two adjacent straight lines at the upper and lower sides, respectively, as long as the current directions in the adjacent two straight lines are designed to be opposite during the layout process, the circuit structure with an odd mode at one side of the straight line and an even mode at another side is achieved.

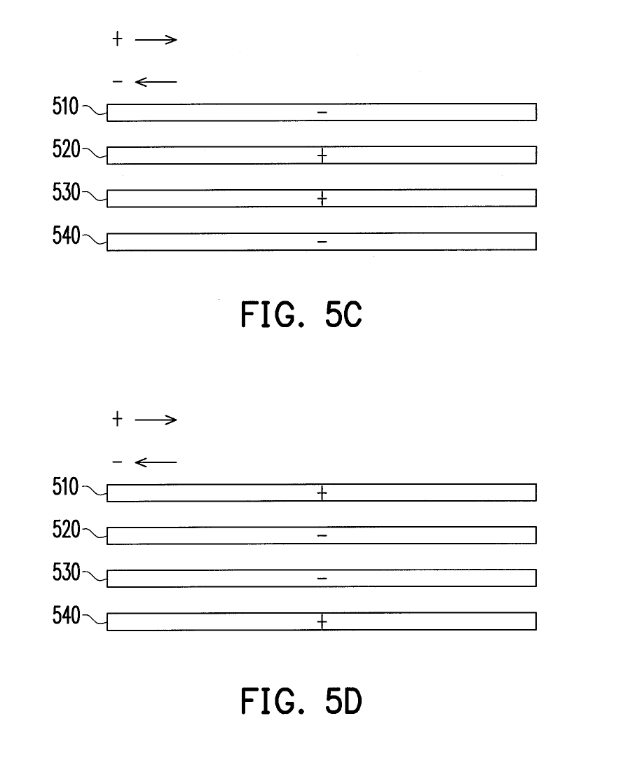

In addition, from the perspective of equivalent impedance and time delay, the delay line 300 in the embodiment further has preferable equivalent impedance and low time delay. FIG. 4 is a sectional diagram taken along line I I′ in FIG. 3. As shown in FIG. 4, the straight lines 310, 320 and 330 are disposed at the surface of a substrate 410. The lower surface of the substrate 410 is a reference plane 420 (which may be connected to the ground). To take the straight line 310 in the middle as an example, one side of the straight line 310 is in the odd mode (such as the line 330), and the other side of the straight line 310 is in the even mode (such as the straight line 320). The equivalent impedance Z₃₁₀ may be represented by the equation as follows.

$$\begin{matrix}{Z}_{310} = \sqrt{\frac{{L}_{310} + {L}_{12} - {L}_{13}}{{C}_{310} - {C}_{12} + {C}_{13}}} \\ = \sqrt{\frac{{L}_{310}}{{C}_{310}}}\end{matrix} \qquad ( 1 )$$

The delay time TD₃₁₀ of the straight line 310 may be represented by the equation as follows.

$$\begin{matrix}T {D}_{310} = \sqrt{( {L}_{310} + {L}_{12} - {L}_{13} ) ( {C}_{310} - {C}_{12} + {C}_{13} )} \\ = \sqrt{{L}_{310} {C}_{310}}\end{matrix} \qquad ( 2 )$$

The Z₃₁₀ represents the equivalent impedance of the straight line 310. The TD₃₁₀ represents the delay time of the straight line 310. The C₃₁₀ represents the equivalent capacitance between the straight line 310 and the reference plane 420. The L₃₁₀ represents the self inductance of the straight line 310. The C₁₂ represents the equivalent capacitance between the straight line 310 and the straight line 320. The C₁₃ represents the equivalent capacitance of the straight line 310 and the straight line 330. The L₁₂ represents the mutual inductance between the straight line 310 and the straight line 320. The L₁₃ represents the mutual inductance between the straight line 310 and the straight line 330. The C₁₂ equals to C₁₃, and the L₁₂ equals to L₁₃.

From the result of the Z₃₁₀, the equivalent impedance of the straight line 310 disposed between the straight lines 320 and 330 is close to the equivalent impedance of a single line, and it is not affected by the straight lines 320 and 330. Thus, the equivalent impedance of the whole delay line 300 is close to the equivalent impedance of a straight line having the same length, and thus the occurrence of impedance mismatch is infrequent in the circuit design. The delay time TD₃₁₀ of the straight line 310 is also close to the equivalent delay time of the single line. In other words, according to the technique of the invention, as long as the current directions of the upper straight line and the lower straight line adjacent to the straight line in the middle are opposite, the cross talk effect between the straight lines is reduced. Thus, the signal transmitting characteristic of the delay line 300 is close to that of the straight line having the same length.

In addition, if the current directions of the straight lines 320 and 330 are the same (that is, the upper and lower sides of the straight line 320 are in odd modes) the equivalent impedance Z₃₁₀ of the straight line 310 and the delay time TD₃₁₀ may be represented by the equation as follows.

$$\begin{matrix}\begin{matrix}{Z}_{310} = \sqrt{\frac{{L}_{310} - {L}_{12} - {L}_{13}}{{C}_{310} + {C}_{12} + {C}_{13}}} \\ = \sqrt{\frac{{L}_{310} - 2 {L}_{12}}{{C}_{310} + 2 {C}_{12}}}\end{matrix} & ( 3 ) \\ \begin{matrix}T {D}_{310} = \sqrt{( {L}_{310} - {L}_{12} - {L}_{13} ) ( {C}_{310} + {C}_{12} + {C}_{13} )} \\ = \sqrt{( {L}_{310} - 2 {L}_{12} ) ( {C}_{310} + 2 {C}_{12} )}\end{matrix} & ( 4 )\end{matrix}$$

From the above equations (3) and (4), if the two straight lines at the upper and lower sides of the straight line 310 are in the odd modes, the equivalent impedance Z₃₁₀ may be affected by the adjacent straight lines and change. The delay time TD₃₁₀ also may be affected and reduced due to the signal coupling, the cross talk and other factors, and then a signal advancing effect may be generated.

To sum up, the circuit structure of the delay line in the embodiment may be designed according to the odd-even mode balance, and the current directions of the upper and lower straight lines adjacent to an individual straight line are opposite. For example, when two straight lines are considered as a line group, straight lines in the same line group have the same current directions. The current directions of the adjacent line groups are opposite. In addition, the delay line in the embodiment is not affected by the position of the reference plane (such as the ground), and as long as the current directions of the straight lines are in accordance with the current directions in the embodiment, the cross talk may be reduced.

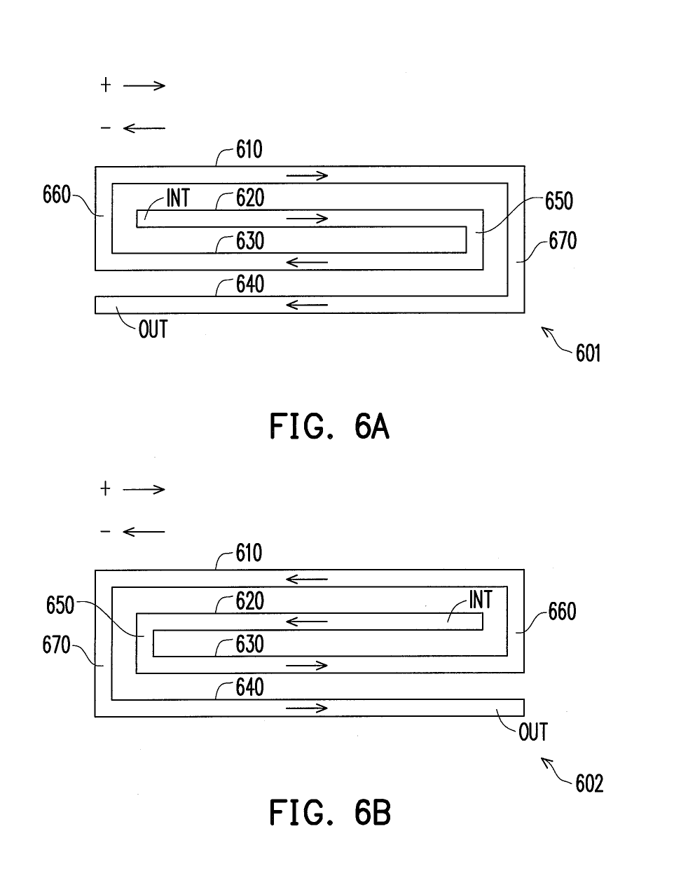

Four adjacent straight lines in the delay line are taken as an example. FIG. 5A to FIG. 5D are schematic diagrams showing the current directions of the straight lines according to the embodiment of the invention. The symbol + represents that the current direction is rightward, and the symbol − represents that the current direction is leftward. As shown in FIG. 5A, the current directions of the adjacent straight lines 510 to 540 are ++−− sequentially, and to the straight line 520 or 530, the current directions of the adjacent straight lines at the upper side and the lower side are opposite to meet the odd-even mode balance circuit structure. Thus, the cross talk effect may be counteracted and reduced, and the delay time and the impedance matching of the whole delay line also may be close to the straight line having the same length. In addition, the embodiment also provides a plurality of modes of designing the delay line meeting the odd-even mode balance circuit structure. As shown in FIG. 5B to FIG. 5D, the current directions of the adjacent straight lines are −−++, −++− and +−−+. They all meet the odd-even mode balance circuit structure and have the effect of improving the impedance matching and reducing the signal advancing effect. The circuit principle is the same as the above, and it is not illustrated herein for concise purpose.

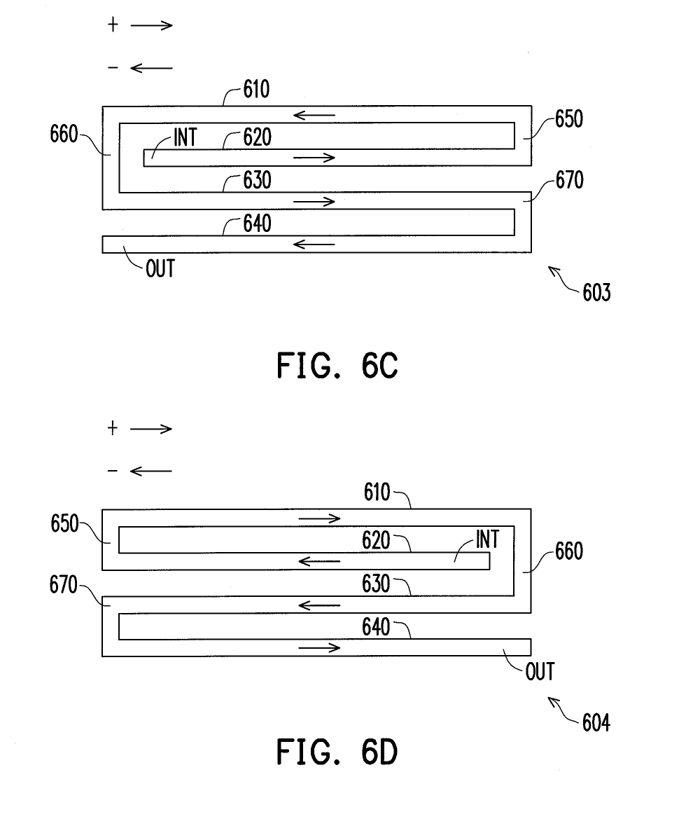

In FIG. 5A to FIG. 5D, the current directions of the straight lines in the delay line are illustrated. The actual layout structure of the delay line is described to illustrate how to achieve the current directions in the FIG. 5A to FIG. 5D. FIG. 6A to FIG. 6D are schematic diagrams showing the delay line corresponding to FIG. 5A to FIG. 5D. As shown in FIG. 6A, the delay line 601 includes straight lines 610 to 640 and connecting lines 650 to 670. The straight lines 610 to 640 are parallel with each other and have the same intervals, and the connecting lines 650 to 670 are mainly used to connect the straight lines 610 to 640. In FIG. 6A, the connecting line 650 is used to connect the straight lines 620 and 630, and the connecting line 660 is used to connect the straight lines 630 and 610, and the connecting line 670 is used to connect the straight lines 610 and 640. The straight lines 610 to 640 and the connecting lines 650 to 670 wind from inside to outside clockwise to form a spiral trace, as shown by the delay line 601.

In the delay line 601, the straight lines 610 to 640 are parallel to each other, and the distances between them are the same. If the current flows from inside to outside, the current direction of each straight line may be derived from the delay path. As shown in FIG. 6A, the current directions of the straight lines 610 and 620 are the same, and they are both rightward. The current directions of the straight lines 630 and 640 are the same, and they are both leftward. Taking the straight line 620 having two adjacent straight lines 610 and 630 at the upper side and lower side as an example, the current direction of the straight lines 610 and 630 are opposite, and the odd-even mode balance circuit structure is formed. To the straight line 630 in the middle, the current directions of the adjacent straight lines 620 and 640 are opposite. As shown in FIG. 5A and FIG. 6A, the current directions formed by the delay line 601 are ++−− from upper to lower sequentially, which corresponds to the current direction required in FIG. 5A, and therefore, the delay line 601 may counteract the cross talk effect and improve the impedance matching.

In FIG. 6B, the delay line 602 winds from inside to outside counter-clockwise, and the circuit directions of the straight lines from top to bottom are −−++ to correspond to the current directions required in FIG. 5B. The current directions of the delay line 603 in FIG. 6C are −++− to correspond to the current direction required in FIG. 5C. In FIG. 6D, the current directions of the delay line 604 are +−−+ to correspond to the current direction in FIG. 5D. Since the delay lines in FIG. 6B to FIG. 6D meet the odd-even mode balance circuit structure, they all may counteract the cross talk effect and improve the impedance matching. As for other circuit operation principles of the delay lines in FIG. 6B to FIG. 6D, please refer to the illustration for FIG. 3 to FIG. 5D, and they are not illustrated herein for a concise purpose. The connecting lines 650 to 670 are used to connect different straight lines 610 to 640 according to the circuit structure of the delay lines 601 to 604, and the corresponding line lengths are adjusted correspondingly. These are shown by FIG. 6A to FIG. 6D, and they are not illustrated herein.

In addition, the straight lines 610 to 640 and the connecting lines 650 to 670 denoted in FIG. 6A to FIG. 6D are in a same circuit board layer (a metal layer). Taking the current path in FIG. 6A to FIG. 6D as an example, an end of the straight line 620 is an input end INT, and a front-end circuit (not shown) may be connected to the input ends INT of the delay lines 601 to 604 through the vias to delay signals, and then it is outputted through the output end OUT of the straight line 620. A back-end circuit (not shown) also may be connected to the output end OUT through the via. The disposing positions of the input end INT and output end OUT may be exchanged, and that is, the current directions of the delay lines 601 to 604 are not limited to be from inside to outside, and they also may be from outside to inside. Thus, the current directions may be opposite to the current directions denoted in FIG. 6A to FIG. 6D, and it also may restrain the cross talk effect.

### The Second Embodiment

The first embodiment provides the basic designing principle of the delay line. However, the number of windings or the whole length of the delay line are not limited in the first embodiment, and the designer may increase or decrease the length of the delay line according to requirements. As long as the odd-even mode balance is met, the cross talk effect may be restrained.

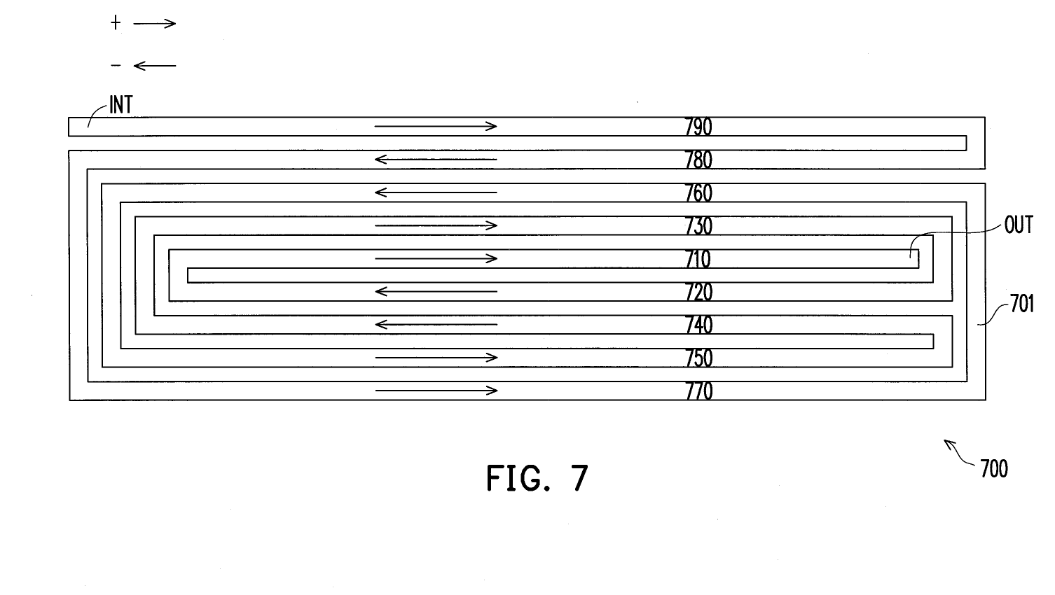

As shown in FIG. 7, it is a schematic diagram showing the delay line in the second embodiment of the invention. The delay line 700 includes straight lines 710 to 790, and the straight lines 710 to 790 are parallel with each other. The straight lines 710 to 740 form a first spiral trace, and the straight lines 750 to 780 form a second spiral trace. The straight lines 710 to 790 are connected end to end via the connecting line (such as the connecting line 701, and others are not denoted) to form the winding delay line 700. The delay line 700 winds for two windings from inside to outside anticlockwise to from the first spiral trace (including the straight lines 710 to 740), and then the direction is changed to be opposite, and it winds for two windings clockwise to form the second spiral trace (including straight lines 750 to 780).

To the circuit path in the embodiment, one end of the straight line 790 is the input end INT, and the other end of the straight line 710 is the output end OUT. A back-end circuit (not shown) may be connected to the output end OUT through the via. The disposing positions of the input end INT and the output end OUT may be exchanged, and it is not limited in the embodiment. In addition, the straight lines 710 to 790 are all disposed in a same circuit layer (a metal layer).

When the current flows from outside to inside, from the delay path formed by the delay line 700, the current directions of the straight lines 710 to 780 from top to bottom may be denoted by −−++−−+, and the current directions of the straight lines 780 and 760 are the same, the current directions of the straight lines 730 and 710 are the same, the current directions of the straight lines 720 and 740 are the same, and the current directions of the straight lines 750 and 770 are the same. In other words, in the straight lines 710 to 780 of the delay line 700, two adjacent straight lines may be considered as a group, and the current directions are the same. The current directions in the next group of the straight lines are opposite.

Thus, in the straight lines 710 to 780, to any straight lines in the middle (such as straight lines 710 to 760), the current directions of the adjacent two straight lines at the upper side and the lower side are opposite (for example, the straight line 710 has two adjacent straight lines 720 and 730 disposed at the upper and lower sides), and the delay line structure which meets the odd-even mode balance is formed. Thus, the delay line 700 may reduce the affection on the signal transmission due to the cross talk effect, and this may avoid the signal advancement and the impedance mismatch. Since in the embodiment, not only the affection on the signal transmission due to the cross talk effect is reduced, the distances between the straight lines 710 to 780 may be less than those in the conventional technology. This may further reduce the layout area needed by the delay line.

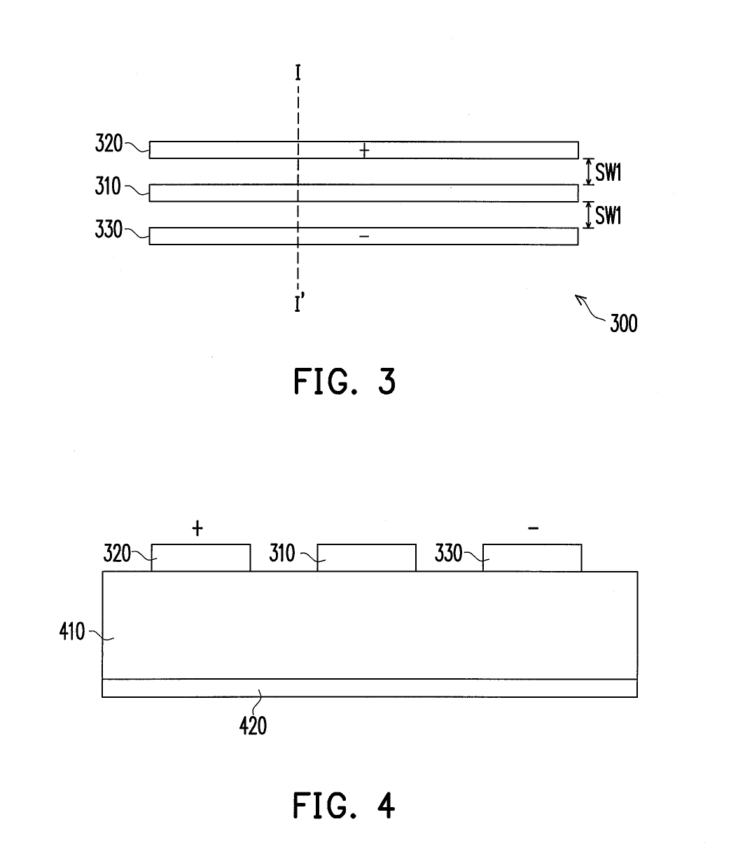

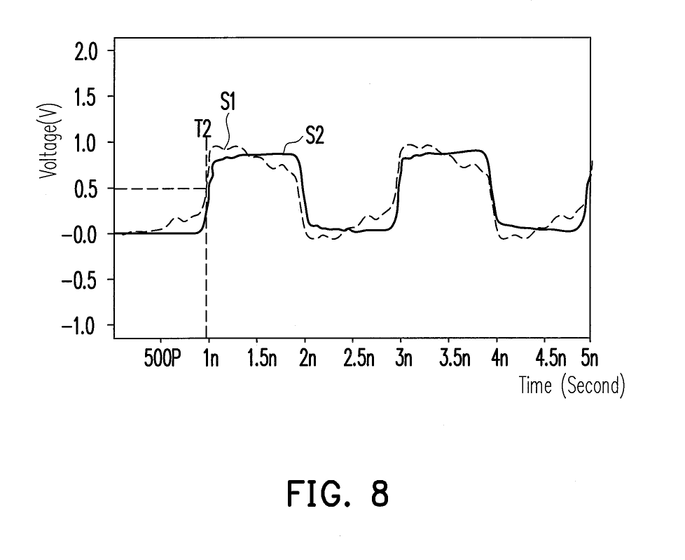

FIG. 8 is a schematic diagram showing the signal waveform according to FIG. 7. The length of the delay line 700 in FIG. 8 is the same with that of the straight line. The signal S1 (dash line) represents the waveform of the signal transmitted by the delay line 700, and the signal S2 (solid line) represents the waveform of the signal transmitted by the straight line. Supposing that a 0.5 volt voltage is used as a reference voltage (such as the reference voltage of the logical high level), as shown in FIG. 8, the time T2 at which the signal S1 reaches the 0.5 volts is close to the time at which the signal S2 reaches the 0.5 volts, and the signal advancement is not serious. As shown in FIG. 8 and FIG. 2 showing the conventional technology, comparing the time T1 with the time T2, the delay line in the embodiment improves the problem of signal advancement in the conventional art.

In addition, when the straight line is longer than the connecting line, the effect of reducing the cross talk is more obvious. Thus, the delay line 700 is preferable rectangular. The distances between the straight lines only may be substantially the same, and it does not matter if deviation is generated in the manufacturing process. In addition, the user also may increase or change part of the layout of the straight lines according to the design requirement. As long as part of the delay line structure meets the odd-even mode balance (that is, adjacent two straight lines have opposite current directions), the effect of reducing the cross talk effect may be achieved. In addition, FIG. 7 is only an embodiment of the invention, and the invention is not limited thereto. A skilled person in the art may obtain other feasible layout modes by reading the disclosure of the invention, and it is not illustrated herein for concise purpose.

To sum up, in the invention, the odd-even balance layout mode is used to make the signal coupling generated in the delay line counteracted. Thus, the cross talk effect may be reduced, and signal advancement and impedance mismatch may be avoided. In the invention, the delay line design may be directly used in the PCB or the chipset, and compared with the conventional technology, the distances between lines in the delay line of the invention are less, and the same delay path is obtained with less layout area. This may reduce the layout area and the design cost.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A delay line adapted to a printed circuit board (PCB), the delay line comprising:
a first straight line;
a second straight line adjacent to a side of the first straight line; and
a third straight line adjacent to the other side of the first straight line;
wherein the first straight line, the second straight line and the third straight line are parallel with each other and form a delay path, and the current direction of the second straight line is opposite to the current direction of the third straight line.

2. The delay line according to claim 1, further comprising:
a first connecting line for connecting an end of the first straight line and an end of the second straight line; and
a second connecting line for connecting the other end of the second straight line and an end of the third straight line;
wherein the first straight line, the second straight line, the third straight line, the first connecting line and the second connecting line form the delay path.

3. The delay line according to claim 1, wherein the current direction of the first straight line is the same as the current direction of the third straight line.

4. The delay line according to claim 1, wherein the distance between the first straight line and the second straight line equals to the distance between the first straight line and the third straight line.

5. The delay line according to claim 1, wherein the delay path is spiral.

6. The delay line according to claim 1, further comprising:
a fourth straight line adjacent to the second straight line and parallel with the second straight line, wherein an end of the fourth straight line is connected to an end of the third straight line, and the current direction of the fourth straight line is the same as the current direction of the second straight line.

7. The delay line according to claim 1, further comprising:
a fourth straight line adjacent to the third straight line and parallel with the third straight line, wherein an end of the fourth straight line is connected to an end of the third straight line, and the current direction of the fourth straight line is opposite to the current direction of the third straight line.

8. A delay line adapted to a PCB, the delay line comprising:
a line group having a first straight line and a second straight line, wherein the current direction of the first straight line is the same as the current direction of the second straight line; and
a third straight line, wherein the third straight line is adjacent to the line group, and the current direction of the third straight line is opposite to the current direction of the line group;
wherein the first straight line, the second straight line and the third straight line are parallel with each other to form a delay path.

9. The delay line according to claim 8, further comprising:
a first connecting line for connecting an end of the first straight line and an end of the second straight line; and
a second connecting line for connecting the other end of the second straight line and an end of the third straight line;
wherein the first straight line, the second straight line, the third straight line, the first connecting line and the second connecting line form the delay path.

10. The delay line according to claim 8, wherein the distance between the first straight line and the second straight line equals to the distance between the first straight line and the third straight line.

11. The delay line according to claim 8, wherein the delay path is spiral.

12. The delay line according to claim 8, further comprising:
a fourth straight line adjacent to the second straight line and parallel with the second straight line, wherein an end of the fourth straight line is connected to an end of the third straight line, and the current direction of the fourth straight line is opposite to the current direction of the second straight line.

13. A delay line adapted to a PCB, the delay line comprising:
a plurality of first straight lines which are parallel with each other;
a plurality of first connecting lines for connecting the first straight lines, respectively, wherein the first straight lines and the first connecting lines wind from inside to outside along a first direction to form a first spiral trace;
a plurality of second straight lines which are parallel with each other; and
a plurality of second connecting lines for connecting the second straight lines, wherein the second straight lines and the second connecting lines wind from inside to outside along a second direction to form a second spiral trace;
wherein the second spiral trace is located at the peripheral of the first spiral trace, and an end of the second spiral trace is connected to an end of the first spiral trace to form a delay path.

14. The delay line according to claim 13, wherein the first spiral trace is formed by four first straight lines and three first connecting lines, and the second spiral trace is formed by four second straight lines and three second connecting lines.

15. The delay line according to claim 13, wherein the first straight lines are parallel with the second straight lines, and the distances between the first straight lines and the second straight lines are the same.

16. The delay line according to claim 13, wherein the lengths of the first straight lines are greater than the lengths of the first connecting lines, and the lengths of the second straight lines are greater than the lengths of the second connecting lines.

17. The delay line according to claim 13, wherein when the first direction is counter-clockwise, the second direction is clockwise, and when the first direction is clockwise, the second direction is counter-clockwise.
